(19) United States
(12) Patent Application Publication
(10) Pub. No.: US 2012/0204099 A1
(43) Pub. Date: Aug. 9, 2012

(54) DISPLAY CONTROL METHOD, DISPLAY APPARATUS, AND ELECTRONIC APPARATUS

(75) Inventor: Yusuke YAMADA, Matsumoto-shi (JP)

(73) Assignee: SEIKO EPSON CORPORATION, Tokyo (JP)

(21) Appl. No.: 13/367,185

(22) Filed: Feb. 6, 2012

(30) Foreign Application Priority Data
Feb. 9, 2011 (JP) 2011-026365

(51) Int. Cl. G06F 17/00

(52) U.S. Cl. 715/244

(57) ABSTRACT

A display control method for displaying thumbnail images of respective pages of one document having a plurality of pages on a display unit includes: generating an image in which respective thumbnail images of the plurality of pages are arranged in a predetermined direction based on the sequence of pages so as to partially overlap with adjacent thumbnail images, at least a thumbnail image of a first selected page selected from the plurality of pages is disposed on the frontmost surface, and the gap between a thumbnail image of a second selected page other than the first selected page and a thumbnail image of a page which is before or after the second selected page is larger than before the second selected page is selected; and displaying the generated image in the generating on the display unit.

### BACKGROUND

1. Technical Field

The present invention relates to a display control method, a display apparatus, and an electronic apparatus.

2. Related Art

As a technique of displaying a document made up of a plurality of pages, techniques disclosed in JP-A-2006-313485 and JP-A-2008-301502 are known, for example. In an ebook display apparatus disclosed in JP-A-2006-313485, thumbnail images of five pages are arranged in one screen in a staircase pattern form, and a page positioned at the center is displayed in a larger size than the other pages. In the ebook display apparatus, the first to fifth pages are displayed, and the third page is displayed at the center, for example. In this case, when an UP key is operated, the thumbnail images are scrolled above the staircase, the display of the first page is removed, and a new sixth page is displayed. Moreover, in an image processing apparatus disclosed in JP-A-2008-301502, thumbnail images of pages are displayed in a screen in a matrix form. When it is not possible to display all pages in the screen, the thumbnail images of pages which could not be displayed in the screen are displayed by scrolling the screen. When a user designates a page from a list of pages, only the designated page is displayed in an enlarged size.

However, when reading a page of a document, the user may want to find pages different from the reading page while leaving the reading page open as it is. In this case, if the document is a paper book, for example, the user can find the other pages while rolling pages by interposing the reading page between fingers to remain open as it is. However, in the case of the ebook display apparatus disclosed in JP-A-2006-313485, when finding pages, the user has to scroll the pages. Thus, it is not possible to display the content of a page distant from a page being viewed while displaying the page being viewed as it is and to allow the user to find the page. Moreover, in the case of the image processing apparatus disclosed in JP-A-2008-301502, when a user finds other pages positioned away from a designated page being viewed, the user has to display a list of pages and then designate the new page. Thus, it is not possible to display the content of a page distant from a page being viewed while displaying the page being viewed as it is and to allow the user to find the page.

### SUMMARY

An advantage of some aspects of the invention is that it enables users to easily find other pages while displaying one page of a document.

An aspect of the invention is directed to a display control method for displaying thumbnail images of respective pages of one document having a plurality of pages on a display unit, including: generating an image in which respective thumbnail images of the plurality of pages are arranged in a predetermined direction based on the sequence of pages so as to partially overlap with adjacent thumbnail images, at least a thumbnail image of a first selected page selected from the plurality of pages is disposed on the frontmost surface, and the gap between a thumbnail image of a second selected page other than the first selected page and a thumbnail image of a page which is before or after the second selected page is larger than before the second selected page is selected; and displaying the image generated in the generating on the display unit.

According to the display control method of the above aspect, the thumbnail image of the first selected page selected within the document is displayed on the frontmost surface, and the gap between the thumbnail image of the second selected page other than the first selected page and the thumbnail image of a page which is before or after the second selected page is larger than before the second selected page is selected. Therefore, the user can easily understand the content of the thumbnail image of the second selected page and easily find pages other than the first selected page.

In the display control method of the above aspect of the invention, the respective thumbnail images of the plurality of pages may be images in which the corresponding page is erected on a horizontal plane provided within an imaginary space and rotated from a predetermined reference position within the imaginary space about an imaginary rotation axis crossing the horizontal sides of the page, and the page is viewed from above within the imaginary space.

According to this configuration, the thumbnail image of the page becomes an overhead-view image of the page erected on a horizontal plane. Thus, the upper part of the page is visible. Even when the thumbnail images of a plurality of pages are displayed in an overlapped manner, the user can easily understand the contents of pages other than the first selected page.

In the display control method of the above aspect of the invention, a rotation angle of the thumbnail image of the second selected page may be smaller than the rotation angle of each of the thumbnail images of pages which are before and after the second selected page.

According to this configuration, since the rotation angle of the thumbnail image of the second selected page is smaller than the rotation angle of the thumbnail images of the pages which are before and after the second selected page, the user can easily understand the content of the second selected page.

In the display control method of the above aspect of the invention, a plan-view image of the first selected page having a larger size than the thumbnail image may be displayed together with the respective thumbnail images of the plurality of pages.

According to this configuration, since the first selected page is displayed in a larger size than the thumbnail images, the user can understand the details of the first selected page.

In the display control method of the above aspect of the invention, the display unit may include a plurality of scanning lines, a plurality of data lines, and a plurality of pixels formed corresponding to the intersections between the plurality of scanning lines and the plurality of data lines and changes the gradation of the pixels by a writing operation of applying a voltage to the pixels several times, and the method may further include determining pixels of which the gradation is to be changed among the plurality of pixels by comparing image data representing an image to be newly displayed on the display unit and scheduled image data representing an image scheduled to be displayed on the display unit by the writing operation in progress, and starting the writing operation with respect to pixels which are determined to be the pixels of which the gradation is to be changed and in which the writing operation is not being performed so that the pixels have a gradation set by the image data, and starting the writing operation with respect to pixels which are determined to be the pixels of which the gradation is to be changed and in which the writing operation is being performed so that the pixels have a gradation set by the image data after the writing operation being performed is finished.

According to this configuration, since the writing operation is immediately started with respect to pixels of which the gradation is to be changed and in which the writing operation is not being performed, the user can experience a faster display speed.

Another aspect of the invention is directed to a display apparatus including: a display unit that displays thumbnail images of respective pages of one document having a plurality of pages; a display image generation unit that generates an image in which respective thumbnail images of the plurality of pages are arranged in a predetermined direction based on the sequence of pages so as to partially overlap with adjacent thumbnail images, at least a thumbnail image of a first selected page selected from the plurality of pages is disposed on the frontmost surface, and the gap between a thumbnail image of a second selected page other than the first selected page and a thumbnail image of a page which is before or after the second selected page is larger than before the second selected page is selected; and a controller that causes the image generated by the display image generation unit to be displayed on the display unit.

According to the display apparatus of the above aspect, the thumbnail image of the first selected page selected within the document is displayed on the frontmost surface, and the gap between the thumbnail image of the second selected page other than the first selected page and the thumbnail image of a page which is before or after the second selected page is larger than before the second selected page is selected. Therefore, the user can easily understand the content of the thumbnail image of the second selected page and easily find pages other than the first selected page.

The invention can be realized as an electronic apparatus having the display apparatus as well as the display apparatus.

### BRIEF DESCRIPTION OF THE DRAWINGS

The invention will be described with reference to the accompanying drawings, wherein like numbers reference like elements.

FIG. 1 is a diagram showing an appearance of an electronic apparatus according to an embodiment of the invention.

FIG. 2 is a block diagram showing a hardware configuration of the electronic apparatus.

FIG. 3 is a cross-sectional view of a display unit.

FIG. 4 is a diagram illustrating a circuit configuration of the display unit.

FIG. 5 is a diagram illustrating the configuration of a pixel driving circuit.

FIG. 6 is a block diagram showing the configuration of functions related to displaying of pages and thumbnail images.

FIG. 7 is a flowchart showing the flow of processes executed by the electronic apparatus.

FIG. 8 is a flowchart showing the flow of processes executed by the electronic apparatus.

FIG. 9 is a flowchart showing the flow of processes executed by the electronic apparatus.

FIGS. 10A to 10E are diagrams illustrating a process of modifying thumbnail images.

FIG. 11 is a diagram showing an image displayed on the display unit.

FIG. 12 is a diagram showing an image displayed on the display unit.

FIG. 13 is a diagram showing an image displayed on the display unit.

FIG. 14 is a diagram showing an image displayed on the display unit.

FIG. 15 is a diagram showing an image displayed on the display unit.

FIG. 16 is a block diagram showing the configuration of functions realized by a controller.

FIG. 17 is a flowchart showing the flow of processes performed by the controller.

FIG. 18 is a diagram illustrating an image rewrite operation.

FIG. 19 is a diagram illustrating an image rewrite operation.

FIG. 20 is a diagram illustrating an image rewrite operation.

FIG. 21 is a diagram illustrating an image rewrite operation.

FIG. 22 is a diagram illustrating an image rewrite operation.

FIG. 23 is a diagram illustrating an image rewrite operation.

FIG. 24 is a diagram illustrating an image rewrite operation.

FIG. 25 is a diagram illustrating an image rewrite operation.

FIG. 26 is a diagram illustrating an image rewrite operation.

FIG. 27 is a diagram illustrating an image rewrite operation.

FIG. 28 is a diagram illustrating an image rewrite operation.

FIG. 29 is a diagram illustrating an image rewrite operation.

FIG. 30 is a diagram illustrating an image rewrite operation.

FIG. 31 is a diagram illustrating an image rewrite operation.

FIG. 32 is a diagram illustrating an image rewrite operation.

FIG. 33 is a diagram illustrating an image rewrite operation.

FIG. 34 is a diagram showing an image displayed on the display unit.

FIG. 35 is a diagram showing thumbnail images displayed on the display unit.

FIG. 36 is a diagram showing an image displayed on the display unit.

FIG. 37 is a diagram showing an image displayed on the display unit.

### DESCRIPTION OF EXEMPLARY EMBODIMENTS

### Embodiment

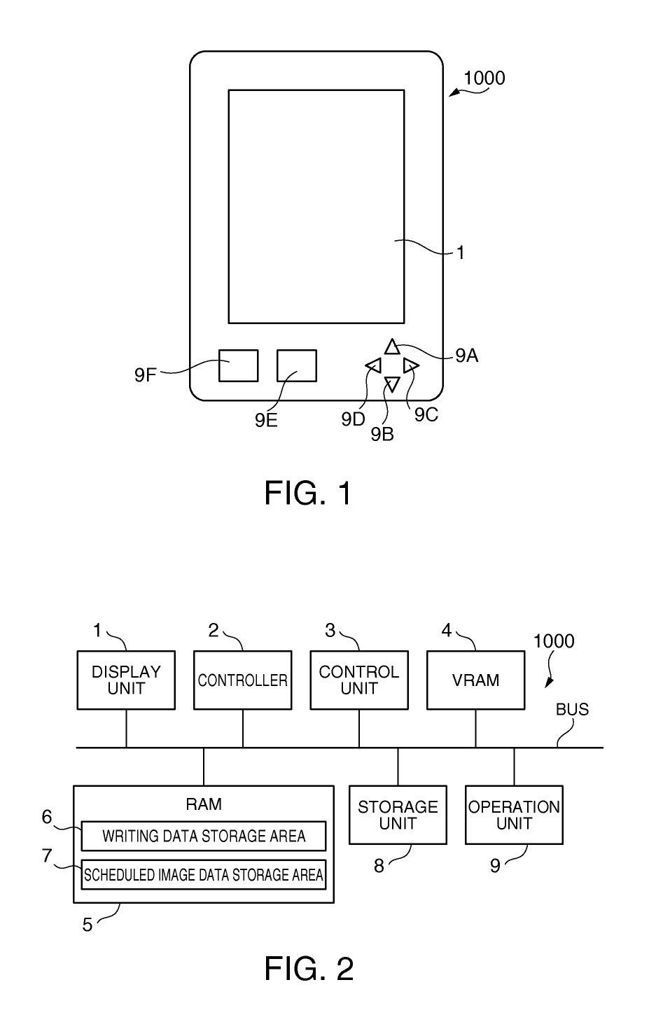

FIG. 1 is a diagram showing an appearance of an electronic apparatus 1000 according to an embodiment of the invention. The electronic apparatus 1000 is an apparatus (commonly called an ebook reader) for browsing an ebook which is an example of a document. The electronic apparatus 1000 displays the pages of an ebook and thumbnails which are reduced images of the respective pages of the ebook. That is, the electronic apparatus 1000 is an example of a display apparatus that displays images. The electronic apparatus 1000 includes a display unit 1 on which images are displayed. Moreover, the electronic apparatus 1000 includes buttons 9A to 9F as operation units operated by a user.

FIG. 2 is a block diagram showing a hardware configuration of the electronic apparatus 1000. As shown in FIG. 2, the respective units of the electronic apparatus 1000 are connected to a bus BUS. The respective units of the electronic apparatus 1000 exchange signals between them through the bus BUS.

The display unit 1 is a display device which includes a display element having a memory effect, and in which a displayed image is maintained even when no voltage is applied to the display element. In the present embodiment, the display unit 1 includes a display element having electrophoretic particles and displays black and white images.

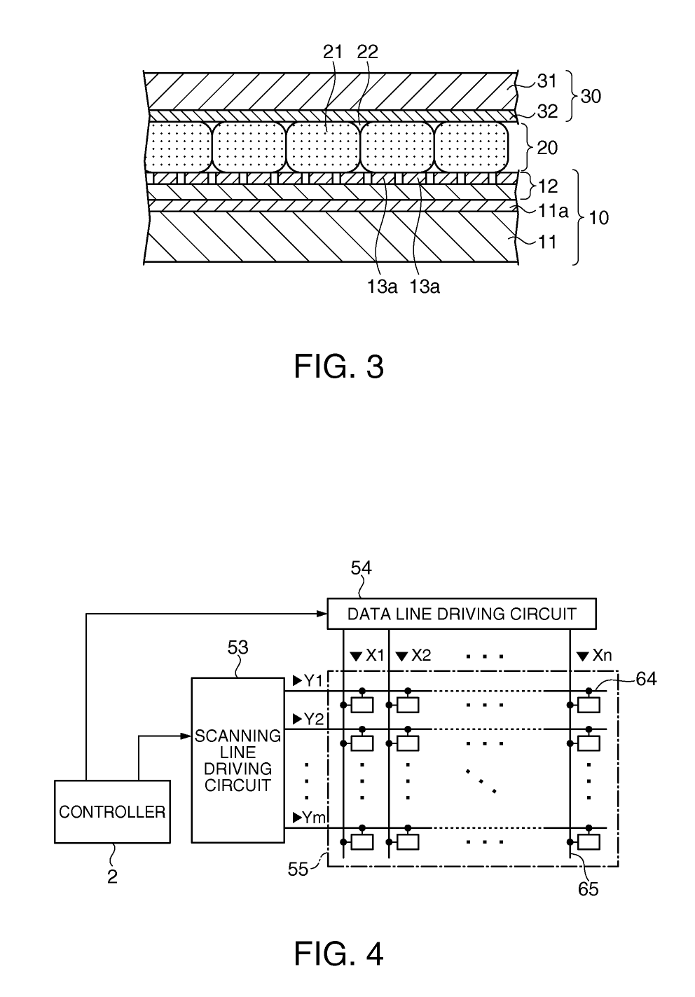

FIG. 3 is a cross-sectional view of the display unit 1. FIG. 4 is a diagram illustrating a circuit configuration of the display unit 1. As shown in FIG. 3, the display unit 1 mainly includes a first substrate 10, an electrophoretic layer 20, and a second substrate 30. The first substrate 10 is a substrate in which a circuit layer is formed on a substrate 11 having insulating and flexible properties. In the present embodiment, the substrate 11 is formed of polycarbonate. The material of the substrate 11 is not limited to polycarbonate, but a resin material which is light, flexible, elastic, and insulative can also be used. Moreover, the substrate 11 may be formed of glass which is not flexible. An adhesive layer 11a is formed on the surface of the substrate 11, and a circuit layer 12 is stacked on the surface of the adhesive layer 11a.

The circuit layer 12 includes a plurality of scanning lines 64 arranged in the horizontal direction and a plurality of data lines 65 arranged in the vertical direction so as to be electrically isolated from the respective scanning lines 64. Moreover, the circuit layer 12 includes a pixel electrode 13a (first electrode) and a pixel driving circuit configured as a TFT (Thin Film Transistor), which are provided at each intersection between the scanning lines 64 and the data line 65.

The electrophoretic layer 20 includes a binder 22 and a plurality of microcapsules 21 fixed by the binder 22 and is formed on the pixel electrodes 13a. An adhesive layer formed by an adhesive agent may be formed between the microcapsules 21 and the pixel electrodes 13a.

The material of the binder 22 is not particularly limited as long as it has favorable affinity to the microcapsules 21, excellent adhesion to electrodes, and insulating properties. A dispersion medium and electrophoretic particles are contained in the microcapsule 21. As the material of the microcapsule 21, materials having flexibility such as gelatin-gum arabic compounds or urethane compounds are preferably used.

Examples of the dispersion medium include any one of water, alcohol solvents (methanol, ethanol, isopropanol, butanol, octanol, methyl cellosolve, and the like), esters (ethyl acetate, butyl acetate, and the like), ketones (acetone, methyl ethyl ketone, methyl isobutyl ketone, and the like), aliphatic hydrocarbons (pentane, hexane, octane, and the like), alicyclic hydrocarbons (cyclo-hexane, methyl cyclo-hexane, and the like), aromatic hydrocarbons (benzene, toluene, benzenes having long-chain alkyl groups (xylene, hexyl-benzene, heptyl-benzene, octyl-benzene, nonyl benzene, decyl benzene, undecyl benzene, dodecyl-benzene, tridecyl-benzene, tetradecyl-benzene, and the like)), halogenated hydrocarbons (methylene chloride, chloroform, carbon tetrachloride, 1,2-dichloroethane, and the like), and carboxylate. Moreover, other oils may be used. These materials may be used alone or as mixtures, and surface active agents may be added thereto as well.

The electrophoretic particles are particles (high polymers or colloids) having such a property that they move within the dispersion medium according to the application of an electric field. In the present embodiment, white and black electrophoretic particles are stored in the microcapsules 21. The black electrophoretic particles are particles made of a black pigment such as, for example, aniline black, carbon black, or the like, and in the present embodiment, are positively charged. The white electrophoretic particles are particles made of a white pigment such as, for example, titanium dioxide, aluminum oxide, or the like, and in the present embodiment, are negatively charged.

The second substrate 30 includes a film 31 and a transparent electrode layer 32 (second electrode) formed on the lower surface of the film 31. The film 31 has the role of sealing and protecting the electrophoretic layer 20 and, for example, is a polyethylene terephthalate film. The film is transparent and has insulating properties. The transparent electrode layer 32 is formed of a transparent conductive film such as, for example, an indium oxide film (ITO film), or the like.

Next, the circuit included in the display unit 1 will be described. The plurality of data lines 65 arranged in parallel in the vertical direction and the plurality of scanning lines 64 arranged in parallel in the horizontal direction are formed in a display region 55 shown in FIG. 4. Moreover, pixel driving circuits are formed in the display region 55 at the intersections between the data lines 65 and the scanning lines 64.

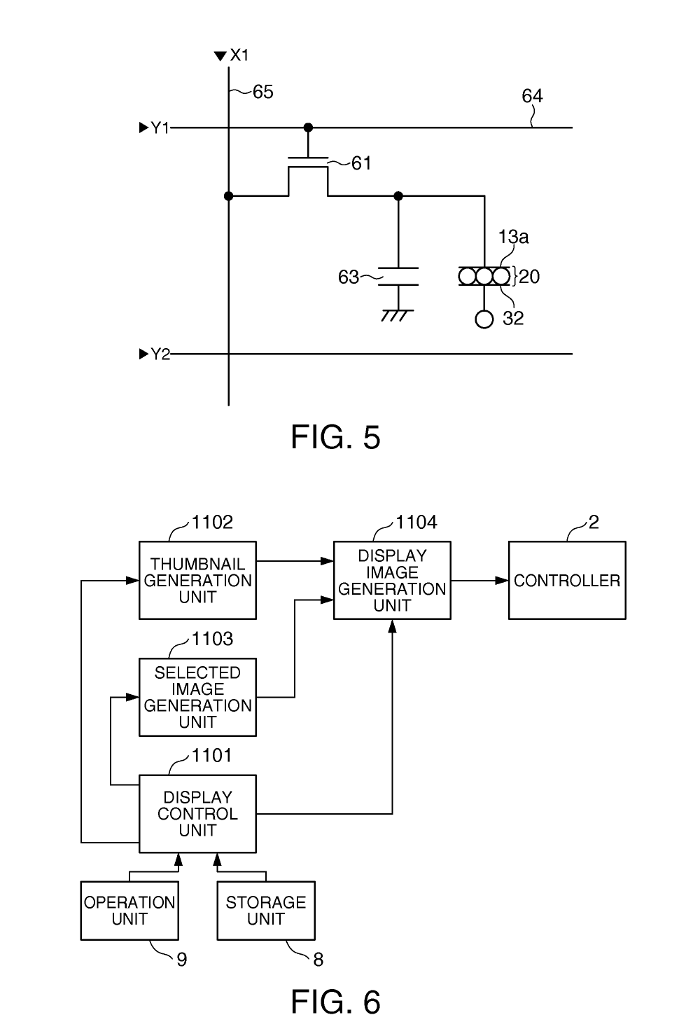

FIG. 5 is a diagram illustrating the configuration of the pixel driving circuit. In the present embodiment, the scanning lines 64 are sometimes referred to as first, second, third, (m-1)-th and m-th scanning lines in that order from the top of FIG. 4 in order to distinguish the respective scanning lines 64 from each other. Similarly, the data lines 65 are sometimes referred to as first, second, third, (n-1)-th and n-th data lines in that order from the left side of FIG. 4 in order to distinguish the respective data lines 65 from each other.

In FIG. 5, a pixel driving circuit corresponding to the intersection between the first scanning line 64 and the first data line 65 is shown. Although the same pixel driving circuits are formed corresponding to the intersections of the other data lines 65 and the other scanning lines 64, since the respective pixel driving circuits have the same configuration, the pixel driving circuit corresponding to the intersection between the first scanning line and the first data line will be representatively described. The description of the other pixel driving circuits will not be provided.

In the pixel driving circuit, the gate of a transistor 61 is connected to the scanning line 64, and the source of the transistor 61 is connected to the data line 65. Moreover, the drain of the transistor 61 is connected to the pixel electrode 13a. The pixel electrode 13a faces the transparent electrode layer 32, and the electrophoretic layer is disposed between the pixel electrode 13a and the transparent electrode layer 32. One microcapsule 21 between the pixel electrode 13a and the transparent electrode layer 32 serves as one pixel of the display unit 1. In the pixel driving circuit, a storage capacitor 63 is connected in parallel to the electrophoretic layer 20. Moreover, the potential of the transparent electrode layer 32 is at a predetermined potential Vcom.

A scanning line driving circuit 53 is connected to the respective scanning lines 64 of the display region 55 so as to supply scanning signals Y1, Y2, . . . , and Ym to the first, second, . . . , and m-th scanning lines 64. Specifically, the scanning line driving circuit 53 sequentially selects the first, second, . . . , and m-th scanning lines 64, sets the voltage of the scanning signal of the selected scanning line 64 to a selection voltage VH (H level), and sets the voltage of the scanning signal of non-selected scanning lines to a non-selection voltage VL (L level).

A data line driving circuit 54 is connected to the respective data lines 65 of the display region 55 so as to supply data signals X1, X2, . . . , and Xn to the first, second, . . . , n-th data lines 65. Data signals are supplied from the data lines 65 to pixel driving circuits connected to the scanning lines 64 of which the potentials are at the selection voltage VH. Specifically, when the scanning line 64 is at the H level, the transistors 61 of which the gates are connected to the scanning line 64 are turned on, and the pixel electrodes 13a are connected to the data lines 65. Therefore, if data signals are supplied to the data lines 65 when the scanning line 64 is at the H level, the data signals are applied to the pixel electrodes 13a through the transistors 61 in the ON state. When the scanning line 64 is at the L level, although the transistors 61 are turned off, the voltage applied to the pixel electrodes 13a in accordance with the data signal is stored in the storage capacitor 63, and electrophoretic particles move in response to a potential difference (voltage) between the potential of the pixel electrode 13a and the potential of the transparent electrode layer 32.

For example, when the transparent electrode layer 32 is at the potential of Vcom and the pixel electrode 13a is at the potential of +15 V, white electrophoretic particles in the negatively charged state move toward the pixel electrode 13a, and black electrophoretic particles in the positively charged state move toward the transparent electrode layer 32, whereby the pixel appears black. Moreover, when the transparent electrode layer 32 is at the potential of Vcom and the pixel electrode 13a is at the potential of −15 V, black electrophoretic particles in the positively charged state move toward the pixel electrode 13a, and white electrophoretic particles in the negatively charged state move toward the transparent electrode layer 32, whereby the pixel appears white.

In the following description, a period after the scanning line driving circuit 53 selects the first scanning line and before selection of the Y-th scanning line is finished will be referred to as a “frame period” or simply “frame”. Each scanning line 64 is selected every frame and the data signal is supplied to each pixel driving circuit every frame.

Returning to FIG. 2, a controller 2 outputs signals for displaying images in the display region 55 and various kinds of signals for driving the display unit 1. A control unit 3 is a microcomputer including a CPU (Central Processing Unit), a ROM (Read Only Memory), a RAM (Random Access Memory), and the like, and controls the respective units of the electronic apparatus 1000 in accordance with a program stored in the ROM. Moreover, the control unit 3 accesses a VRAM (Video RAM) 4 to write various kinds of data to the VRAM 4. The VRAM 4 is a memory that stores image data representing images to be displayed on the display unit 1. The RAM 5 stores data used for displaying images on the display unit 1. The data stored in the RAM 5 will be described later. A storage unit 8 is a nonvolatile memory and stores document data representing an ebook. The storage unit 8 can store data of a plurality of different documents. An operation unit 9 includes buttons 9A to 9F shown in FIG. 1. When anyone of the buttons is operated, a signal indicating the operated button is transmitted to the control unit 3. The control unit 3 acquires the signal transmitted from the operation unit 9 and specifies the operated button. The control unit 3 performs various processes in accordance with the specified button, such as, for example, forward and backward scrolling of ebook pages, or displaying of thumbnail images. The display unit 1, the controller 2, and the control unit 3 may collectively be defined as a display apparatus. Alternatively, the display unit 1, the controller 2, the control unit 3, the VRAM 4, and the RAM 5 may collectively be defined as a display apparatus.

FIG. 6 is a block diagram showing the configuration of functions related to displaying of pages and thumbnail images of an ebook in the electronic apparatus 1000. A thumbnail generation unit 1102 generates thumbnail images of respective pages of a document represented by document data based on data supplied from a display control unit 1101. A selected image generation unit 1103 generates an image (hereinafter referred to as a first selected image) of an open page of an ebook, selected by the user, based on the data supplied from the display control unit 1101. A display image generation unit 1104 acquires the thumbnail images generated by the thumbnail generation unit 1102 and the first selected image generated by the selected image generation unit 1103 and generates an image to be displayed on the display unit 1 using the acquired images.

The display control unit 1101 acquires the signal indicating the operated button of the operation unit 9. Moreover, the display control unit 1101 reads the document data from the storage unit 8 in response to the acquired signal and supplies data of respective pages included in the read document data to the thumbnail generation unit 1102. Furthermore, the display control unit 1101 extracts data of an open page of the ebook, selected by the user from the document data and supplies the extracted data to the selected image generation unit 1103.

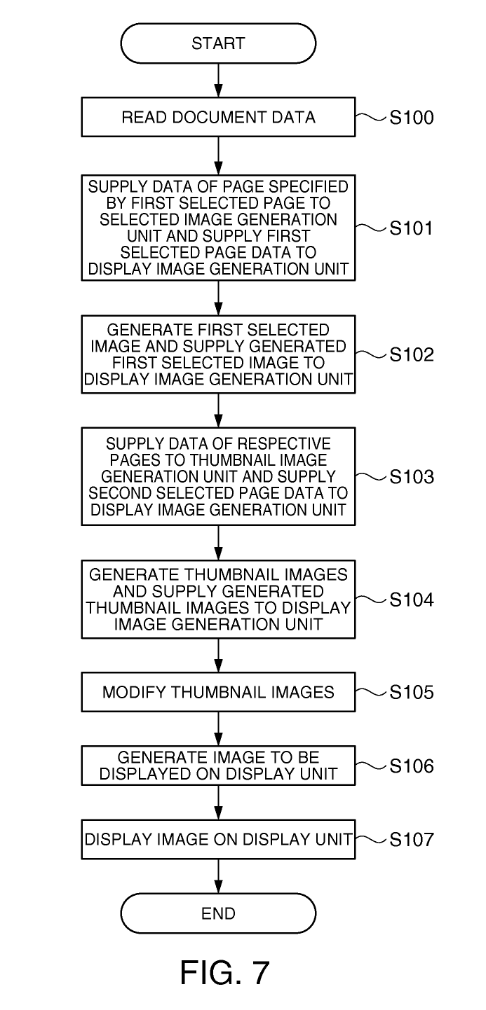

FIGS. 7 to 9 are flowcharts showing the flow of processes executed by the electronic apparatus 1000. Hereinafter, the operation of the electronic apparatus 1000 will be described with reference to FIGS. 7 to 9.

First, when the user operates the operation unit 9 to select one of a plurality of document data stored in the storage unit 8, the display control unit 1101 reads the selected document data from the storage unit 8 (FIG. 7: step S100). The display control unit 1101 includes first selected page data representing the number of an open page (hereinafter referred to as a first selected page) selected by the user. When reading of document data is finished, the display control unit 1101 extracts data of a page specified by the first selected page from the document data, supplies the extracted data to the selected image generation unit 1103, and supplies the first selected page data to the display image generation unit 1104 (step S101). For example, when the value of the first selected page data is “16,” the display control unit 1101 extracts data of page 16 from the document data and supplies the extracted document data to the selected image generation unit 1103. The selected image generation unit 1103 generates an image (first selected image) of the page indicated by the supplied data and supplies the generated first selected image to the display image generation unit 1104 (step S102).

Moreover, the display control unit 1101 includes second selected page data representing the number of a page (hereinafter referred to as a second selected page) corresponding to a thumbnail image selected by the user. The display control unit 1101 supplies the data of respective pages of a document represented by the document data to the thumbnail generation unit 1102 and supplies the second selected page data to the display image generation unit 1104 (step S103). The thumbnail generation unit 1102 generates thumbnail images of respective pages represented by the supplied data and supplies the generated thumbnail images to the display image generation unit 1104 (step S104).

The display image generation unit 1104 generates an image including the supplied first selected image and thumbnail images as an image to be displayed on the display unit 1. The thumbnail images of respective pages are modified so that each page is erected vertically on a horizontal plane and rotated about an imaginary rotation axis crossing the upper and lower sides of the page, and the page is viewed in the same way as when it was viewed (viewed overhead) from a viewpoint above the upper side of the page (step S105).

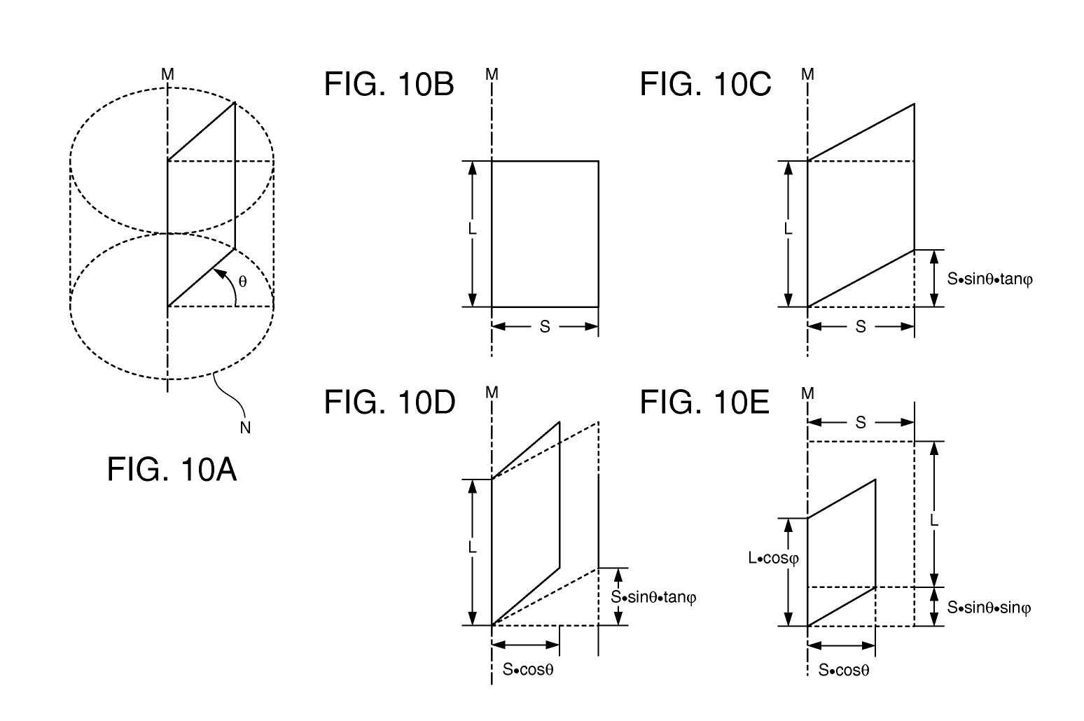

FIGS. 10A to 10E are diagrams illustrating a process of modifying thumbnail images. The respective thumbnail images supplied from the thumbnail generation unit 1102 are plan-view images of pages. As shown in FIG. 10B, each thumbnail image is an image in which the vertical length is L, the horizontal length is S, the vertical sides are parallel to the vertical direction of the display region, and the horizontal sides are parallel to the horizontal direction of the display region. The display image generation unit 1104 modifies the respective thumbnail images representing the pages to thereby generate images so that as shown in FIG. 10A, each page is erected on a horizontal plane N in an imaginary space and rotated about an imaginary rotation axis M crossing the upper and lower sides of the page and extending along the vertical sides of the page by a rotation angle θ from a reference position at which the horizontal direction of the page is parallel to the horizontal direction of the display region, and the page is looked down (viewed overhead) at an overhead angle φ from a viewpoint above the upper side of the page within the imaginary space. When the page is not rotated, the horizontal direction of the page is parallel to the horizontal direction of the display region, and the rotation angle θ is 0°. Moreover, the overhead angle φ is a predetermined angle. Furthermore, the rotation axis M is not limited to a configuration in which it is parallel to the vertical sides of the page but may be configured such that it crosses the horizontal sides of the page.

Specifically, first, the display image generation unit 1104 applies vertical modification to the front-view image of a page (FIG. 10B) supplied from the thumbnail generation unit 1102 without changing the horizontal width as shown in FIG. 10C and shifts the right side of the image of FIG. 10B by S·sin θ·tan φ in relation to the left side. Subsequently, the display image generation unit 1104 reduces the horizontal size of the image of FIG. 10C with a magnification of cos θ as shown in FIG. 10D. As a result, the horizontal width becomes S·cos θ. Lastly, the display image generation unit 1104 reduces the vertical size of the image of FIG. 10D with a magnification of cos φ as shown in FIG. 10E.

In this way, the page is rotated about the imaginary rotation axis M by the rotation angle θ and an image when the page is viewed from above at the overhead angle φ from the viewpoint above the upper side of the page is obtained. The rotation angle is set to a predetermined rotation angle θ1 for the first selected page specified by the first selected page data, and is set to a predetermined rotation angle −θ1 for a page which is one page before the first selected page. Moreover, as for pages other than the first selected page, the rotation angle gradually increases as the difference in page number from the first selected page increases. In the present embodiment, the rotation angle for pages after the first selected page is in the range of θ1<θ<90°. In the present embodiment, the rotation angle for pages before the first selected page is in the range of −θ1>−θ>−90°.

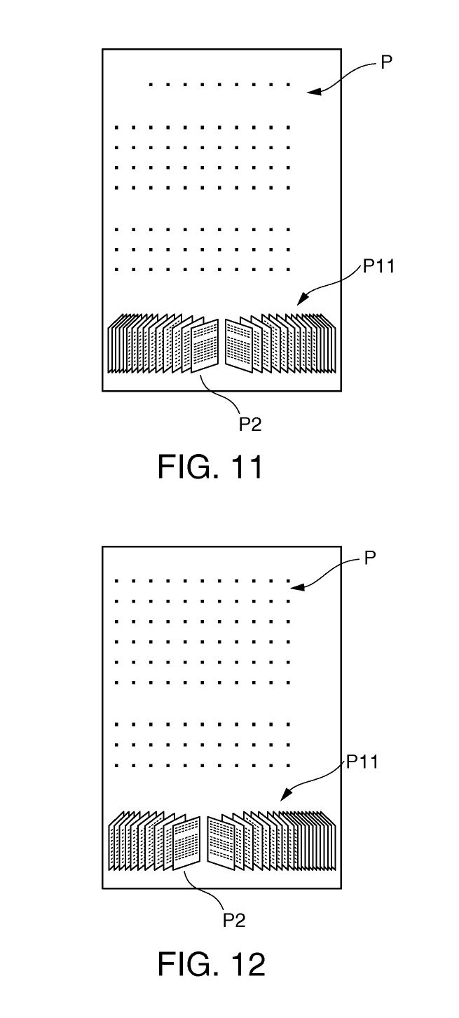

After modification of the thumbnail images is finished, the display image generation unit 1104 performs a display image generation step of generating images to be displayed on the display unit 1 (step S106). Specifically, as shown in FIG. 11, the display image generation unit 1104 generates an image in which the supplied first selected image P is arranged in the entire display region and the modified thumbnail images P11 are arranged under the first selected image P in an overlapped manner in ascending order of page numbers from the right to the left of the display region. In FIG. 11, characters described in each page of the image are depicted by “•” for the sake of brevity. Moreover, among the thumbnail images P11, a thumbnail image of the first selected page is a thumbnail image P2. Here, the display image generation unit 1104 arranges the modified thumbnail images so that as shown in FIG. 11, the thumbnail images partially overlap with adjacent thumbnail images, and the gap between thumbnail images decreases as the distance to the thumbnail image of the first selected page increases. Moreover, the thumbnail image of the first selected page and the thumbnail image of a page which is one page before the first selected page are arranged so that the entire surfaces of the pages are viewable. Furthermore, the display image generation unit 1104 increases the gap between the thumbnail image of the second selected page and the thumbnail images of pages which are before and after the second selected page so that the content of the thumbnail image of a page represented by the second selected page data can be browsed. When the first and second selected pages are the same, the display image generation unit 1104 generates the image as shown in FIG. 11 without increasing the gap between the second selected page and the pages which are before and after the second selected page.

After generating the image including the image of the first selected page and the thumbnail images, the display image generation unit 1104 supplies the generated image to the controller 2. The controller 2 enters a display step of displaying image and controls the display unit 1 so that the supplied image is displayed. In this way, the display unit 1 displays the image shown in FIG. 11 (step S107). When the image shown in FIG. 11 is displayed, since the first selected page is displayed on the entire display region of the display unit 1, the user can read the first selected page. Moreover, since pages other than the first selected page are displayed as thumbnail images, the user can understand the outlines of the respective pages. Furthermore, since the thumbnail images are displayed with the first selected page open as in the case of a paper book, the user can know the location of the page of the ebook that the user is reading.

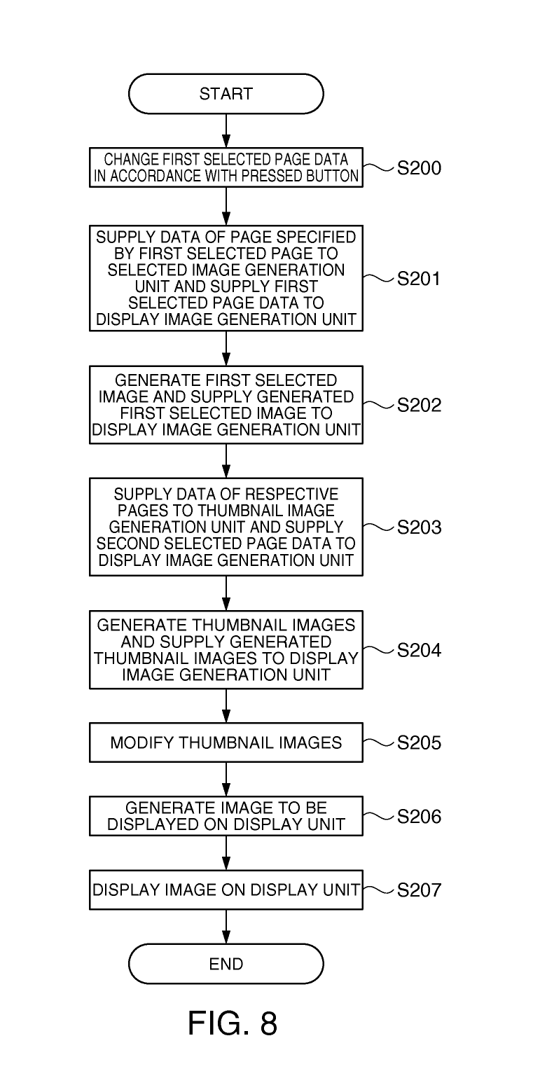

Subsequently, the operation when forward and backward scrolling of ebook pages are performed will be described. The display control unit 1101 adds “1” to the value of the first selected page data when the button 9F is pressed and subtracts “1” from the value of the first selected page data when the button 9E is pressed (FIG. 8: step S200). After changing the value of the first selected page data, the display control unit 1101 extracts data of a page specified by the changed first selected page data from the document data, supplies the extracted data to the selected image generation unit 1103, and supplies the first selected page data to the display image generation unit 1104 (step S201).

For example, page 16 is the first selected page in FIG. 11. When the button 9F is pressed in this state so that the first selected page is changed to page 21, the display control unit 1101 extracts data of page 21 from the document data and supplies the extracted data to the selected image generation unit 1103. Upon receiving the data of page 21, the selected image generation unit 1103 generates an image of page 21 based on the supplied data and supplies the generated image to the display image generation unit 1104 (step S202).

Moreover, the display control unit 1101 supplies the data of respective pages of the document represented by the document data to the thumbnail generation unit 1102 and supplies the second selected page data to the display image generation unit 1104 (step S203). The thumbnail generation unit 1102 generates thumbnail images of respective pages represented by the supplied data and supplies the generated thumbnail images to the display image generation unit 1104 (step S204). The display image generation unit 1104 modifies the supplied thumbnail images to generate an image in which the rotation angle is set to θ1 for the thumbnail image of page 21 specified by the first selected page data and generate an image in which the rotation angle is set to −θ1 for the thumbnail image of page 20. Moreover, the display image generation unit 1104 generates thumbnail images of pages other than the first selected page so that the rotation angle gradually increases as the distance from page 21 increases (step S205).

When the display image generation unit 1104 generates an image including the image of the first selected page and the modified thumbnail images (step S206) and supplies the generated image to the controller 2, an image in which the thumbnail image of page 21 is displayed with the rotation angle θ1 is displayed on the display unit 1 as shown in FIG. 12 (step S207).

Moreover, when the button 9E is pressed in the state shown in FIG. 11, and the first selected page is changed to page 11, the display control unit 1101 extracts data of page 11 from the document data and supplies the extracted data to the selected image generation unit 1103. Upon receiving the data of page 11, the selected image generation unit 1103 generates an image of page 11 based on the supplied data and supplies the generated image to the display image generation unit 1104. Moreover, the display image generation unit 1104 generates an image in which the rotation angle is set to θ1 for the thumbnail image of page 11 and generates an image in which the rotation angle is set to −θ1 for the thumbnail image of page 10. Moreover, the display image generation unit 1104 generates thumbnail images of pages other than the first selected page so that the rotation angle gradually increases as the distance from page 11 increases.

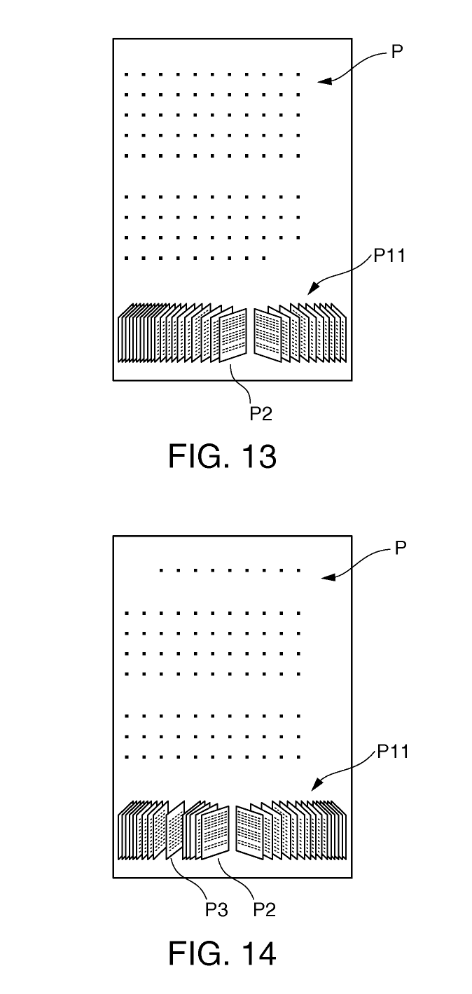

When the display image generation unit 1104 generates an image including the image of the first selected page and the modified thumbnail images and supplies the generated image to the controller 2, an image in which the thumbnail image of page 11 is displayed with the rotation angle θ1 is displayed on the display unit 1 as shown in FIG. 13. As above, when the first selected page is changed, the thumbnail images are also changed, the user can easily understand the page of the ebook that the user is selecting.

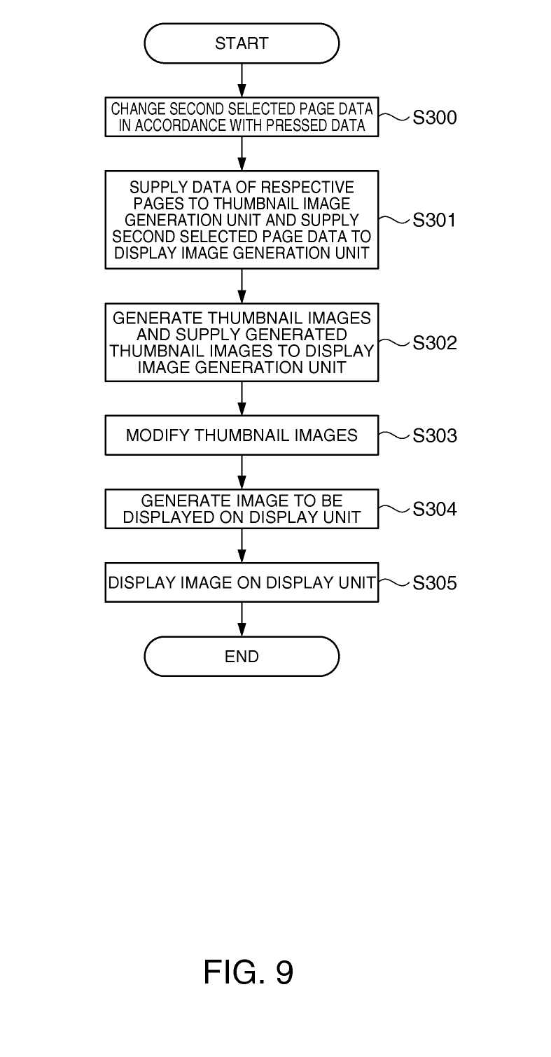

Next, the operation when forward and backward scrolling of the second selected page are performed will be described. The display control unit 1101 adds “1” to the value of the second selected page data when the button 9D is pressed in a state where the thumbnail images are displayed and subtracts “1” from the value of the second selected page data when the button 9C is pressed (FIG. 9: step S301). After changing the value of the second selected page data, the display control unit 1101 supplies data of respective pages of the ebook represented by the document data to the thumbnail generation unit 1102 and supplies the second selected page data to the display image generation unit 1104 (step S301).

The thumbnail generation unit 1102 generates thumbnail images of respective pages represented by the supplied data and supplies the generated thumbnail images to the display image generation unit 1104 (step S302). The display image generation unit 1104 modifies the supplied thumbnail images (step S303).

For example, when the button 9D is pressed in the state shown in FIG. 11 so that the second selected page is changed to page 21, the second selected page data having the value of “21” is supplied from the display control unit 1101 to the display image generation unit 1104. Upon receiving the second selected page data having the value of “21,” the display image generation unit 1104 arranges the thumbnail images by increasing the gaps between page 21 and page 20 and between page 21 and page 22 so that the content of the thumbnail image of page 21 can be browsed. When the display image generation unit 1104 generates an image including the image of the first selected page and the thumbnail images (step S304) and supplies the generated image to the controller 2, an image in which the gap between the thumbnail image P3 of page 21 which is the second selected page and thumbnail images of pages which are before and after page 21 is increased is displayed on the display unit 1 as shown in FIG. 14 (step S305).

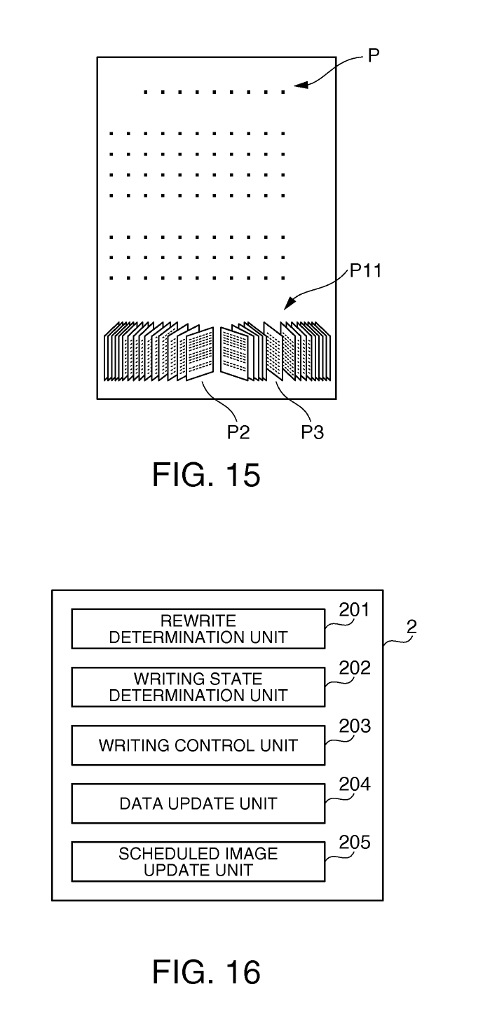

Moreover, when the button 9D is pressed in the state shown in FIG. 11 so that the second selected page is changed to page 10, the second selected page data having the value of “10” is supplied from the display control unit 1101 to the display image generation unit 1104. Upon receiving the second selected page data having the value of “10,” the display image generation unit 1104 arranges the thumbnail images by increasing the gaps between page 10 and page 11 and between page 10 and page 9 so that the content of the thumbnail image of page 10 can be browsed. When the display image generation unit 1104 generates an image including the image of the first selected page and the thumbnail images and supplies the generated image to the controller 2, an image in which the gap between the thumbnail image of page 10 and thumbnail images of pages which are before and after page 10 is increased is displayed on the display unit 1 as shown in FIG. 15.

As above, in the thumbnail images, when the second selected page is changed, the gap between the second selected page and the pages which are before and after the second selected page is increased so that the content of the thumbnail image of the second selected page can be browsed. Therefore, the user can easily understand the content of pages other than the first selected page while browsing the first selected page and can find other pages while viewing the first selected page.

Next, a characteristic configuration that controls the display unit 1 of the present embodiment will be described. In the present embodiment, when changing the display states of respective pixels from white (low-density) to black (high-density) or from black to white, rather than changing the display states by driving the pixel driving circuits for only one frame, the display states are changed by a writing operation of applying a voltage to the pixels over a plurality of frames. This is because even if a potential difference is applied to electrophoretic particles for only one frame when changing the display state from white to black, the black electrophoretic particles do not completely move to the display side, and a perfect black display state is not realized. The same happens to white electrophoretic particles when changing the display state from black to white. Therefore, for example, when changing the display states of pixels from white to black, a data signal for causing pixels to appear black is supplied to the pixel driving circuits over a plurality of frames. Moreover, when changing the display states of pixels from black to white, a data signal for causing pixels to appear white is supplied to the pixel driving circuits over a plurality of frames.

FIG. 16 is a block diagram showing the functions related to displaying of images, of the controller 2 controlling the display unit 1. The controller 2 includes a rewrite determination unit 201, a writing state determination unit 202, a writing control unit 203, a data update unit 204, and a scheduled image update unit 205. These respective blocks may be realized by hardware, and the respective blocks may be realized by providing a CPU in the controller 2 and causing the CPU to execute programs. In the present embodiment, the RAM 5 includes a writing data storage area 6 and a scheduled image data storage area 7.

The rewrite determination unit 201 is a block that compares image data stored in the VRAM 4 with image data stored in the scheduled image data storage area 7 to determine whether the two data are different or not. The writing state determination unit 202 is a block that determines whether a rewrite operation for changing the display states of pixels from black to white or from white to black is progressing by referring to the data stored in the writing data storage area 6. The writing data storage area 6 includes a white writing data storage area 6A that stores data (first writing data) representing whether an operation of changing the display states of respective pixels from black to white is progressing and a black writing data storage area 6B that stores data (second writing data) representing whether an operation of changing the display states of respective pixels from white to black is progressing.

The writing control unit 203 is a block that controls the scanning line driving circuit 53 and the data line driving circuit 54 so that a data signal is supplied to the pixel electrodes 13a. The data update unit 204 is a block that writes data to the white writing data storage area 6A and the black writing data storage area 6B. The scheduled image update unit 205 is a block that overwrites the image data stored in the scheduled image data storage area 7 with the image data stored in the VRAM 4.

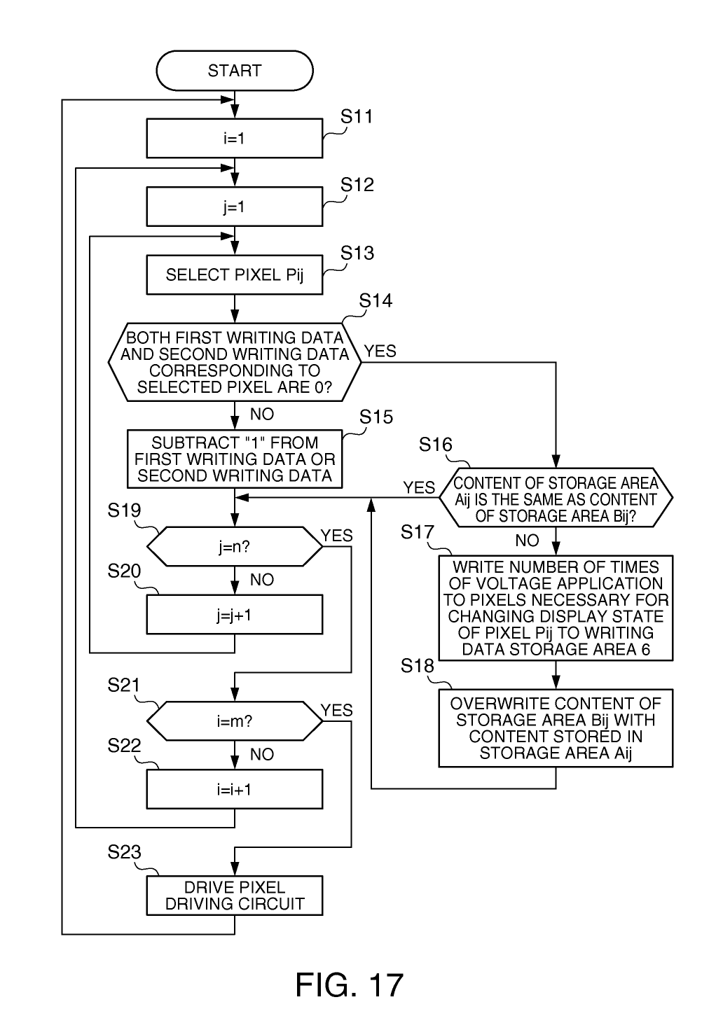

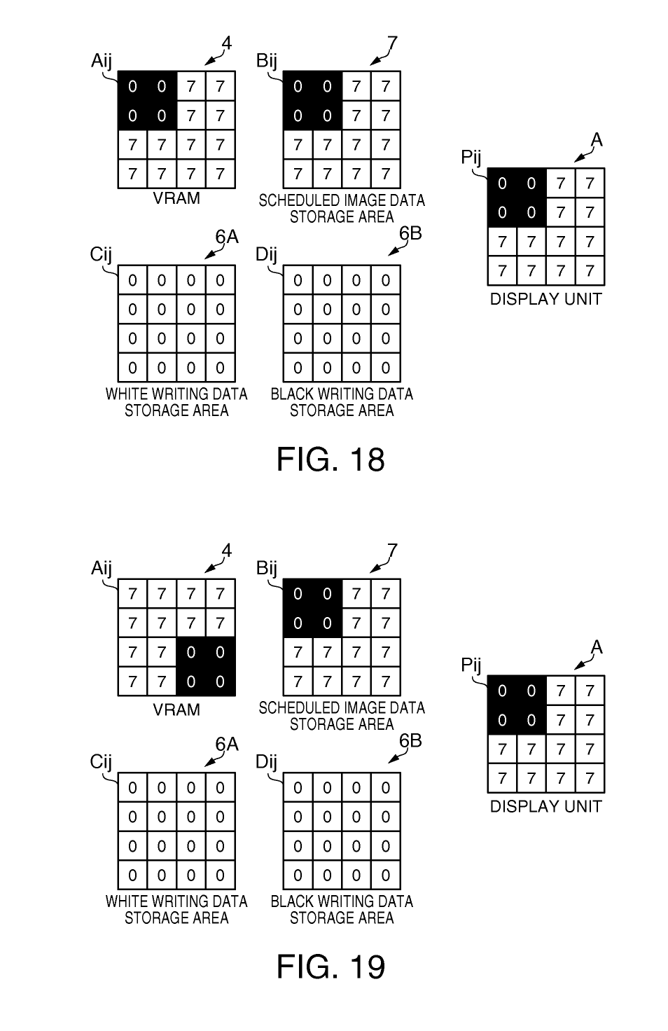

Next, an image rewrite operation will be described with reference to FIGS. 17 to 33. In FIGS. 18 to 33, an image A represents an image displayed on the display unit 1. Moreover, a pixel Pij represents one pixel. Here, the subscripts i and j represent row and column numbers of the pixel in a matrix. Hereinafter, when describing a specific pixel, a pixel on the first row and first column will be referred to as a pixel P11. In the image A, gradations of 8 steps of black to white are represented by numbers of 0 to 7 so that the gradations of respective pixels can be easily understood. However, in practice this number is not displayed. Moreover, in the display unit 1, although pixels are present at every intersection between m scanning lines 64 and n data lines 65, only 4 by 4 pixels P11 to P44 in a part of the display unit 1 are illustrated in FIGS. 18 to 33 for the sake of brevity.

Moreover, in FIGS. 18 to 33, the content of a storage area Aij corresponding to the pixels P11 to P44 in the VRAM 4, the content of a storage area Bij corresponding to the pixels P11 to P44 in the scheduled image data storage area 7, the content of a storage area Cij corresponding to the pixels P11 to P44 in the white writing data storage area 6A, and the content of a storage area Dij corresponding to the pixels P11 to P44 in the black writing data storage area 6B are illustrated. The subscripts i and j of the respective storage areas represent the row and column numbers of the storage area in a matrix. For example, when describing a specific storage area, a storage area Aij on the first row and first column will be referred to as a storage area A11.

The gradations of respective pixels of an image displayed on the display unit 1 are stored in the storage areas All to A44 of the VRAM 4, and the gradations of respective pixels of an image scheduled to be displayed on the display unit 1 are stored in the storage areas B11 to B44 of the scheduled image data storage area 7. The number of times of voltage application necessary for changing the display states of the pixels P11 to P44 to white is stored in the storage areas C11 to C44 of the white writing data storage area 6A as first writing data. The number of times of voltage application necessary for changing the display states of the pixels P11 to P44 to black is stored in the storage areas D11 to D44 of the black writing data storage area 6B as second writing data. When the first and second writing data are not 0, it means the pixel rewrite operation is progressing. When the first and second writing data are 0, it means the pixel rewrite operation is finished.

The controller 2 performs processes shown in FIG. 17 when driving pixels. First, the writing state determination unit 202 initializes the value of variables i and j to “1” (steps S11 and S12). Subsequently, the writing state determination unit 202 selects a pixel Pij specified by the variables i and j (step S13). For example, when the values of the variables i and j are 1 and 1, respectively, the pixel P11 is selected.

Subsequently, the writing state determination unit 202 determines whether both the first writing data stored in the storage area Cij corresponding to the selected pixel Pij and the second writing data stored in the storage area Dij are 0 (step S14). When both the first writing data stored in the storage area Cij corresponding to the selected pixel Pij and the second writing data stored in the storage area Dij are 0 (step S14: YES), the writing state determination unit 202 proceeds to step S16. When any one of the first and second writing data is not 0 (step S14: NO), the writing state determination unit 202 proceeds to step S15. In step S15, the data update unit 204 subtracts “1” from the data having a value other than 0 among the first writing data stored in the storage area Cij and the second writing data stored in the storage area Dij. The subtraction of “1” is not performed with respect to the first or second writing data having the value of 0.

On the other hand, in step S16, in order to determine whether the gradation is changed or not, the rewrite determination unit 201 compares the data stored in the storage area Aij with the data stored in the storage area Bij. Here, when both data are different (step S16: NO), the rewrite determination unit 201 performs a data update step of specifying the pixel Pij as a pixel of which the display state is to be newly changed (specifying step) and updating the data associated with the specified pixel Pij.

In the data update step, the data update unit 204 writes the number of times of voltage application necessary for changing the gradation of the pixel Pij to the gradation of the storage area Aij in the writing data storage area 6 (step S17). Moreover, the scheduled image update unit 205 overwrites the content of the storage area Bij with the content stored in the storage area Aij (step S18).

Subsequently, in step S19, the controller 2 determines whether the value of the variable j is the same as the number n of data lines. Here, if the value of the variable j is not the same as n (step S19: NO), “1” is added to the value of the variable j (step S20), and the flow proceeds to step S13. When the value of the variable j is n, it is determined whether the value of the variable i is the same as the number m of scanning lines. Here, if the value of the variable i is not the same as m (step S21: NO), “1” is added to the value of the variable i (step S22), and the flow proceeds to step S12. When the value of the variable i is m (step S21: YES), the writing control unit 203 drives the pixel driving circuit by controlling the scanning line driving circuit 53 and the data line driving circuit 54 (step S23).

Next, a change in the display of the display unit 1, a change in the content of the VRAM 4, a change in the content of the scheduled image data storage area 7, and a change in the content of the writing data storage area 6 during a period after image data are written to the VRAM 4 and before an image of the image data is displayed on the display unit 1 will be described with reference to FIGS. 18 to 33.

In a state where the display of the display unit 1 and the states of the VRAM 4, the writing data storage area 6, and the scheduled image data storage area 7 are in the state shown in FIG. 18, when the control unit 3 writes image data to the VRAM 4 (data write step), the state of the VRAM 4 is changed to the state shown in FIG. 19 in accordance with the image data.

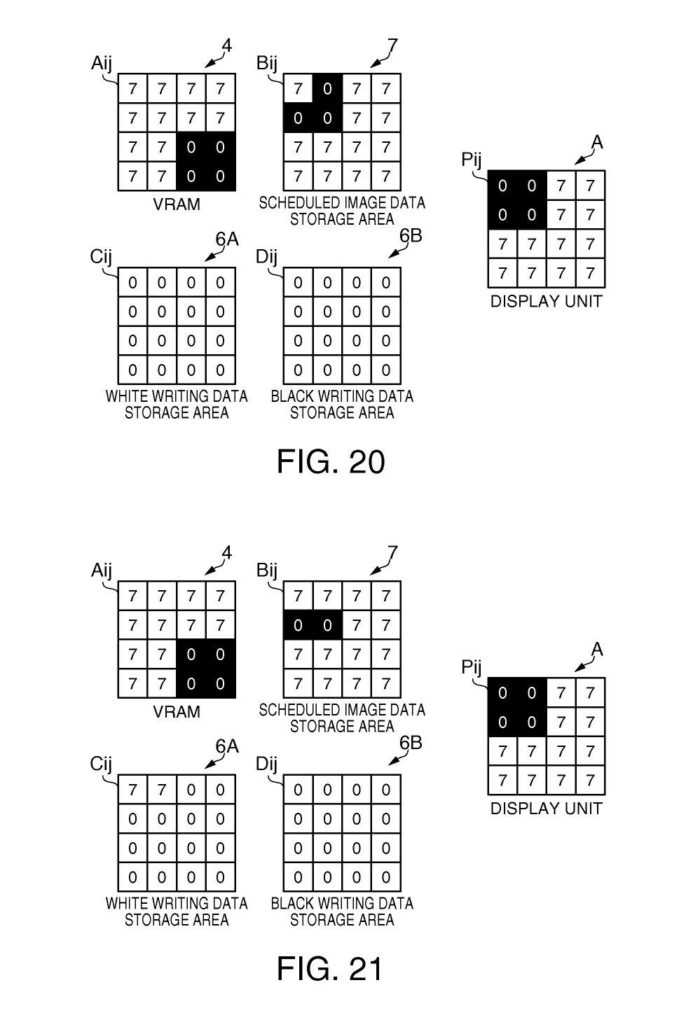

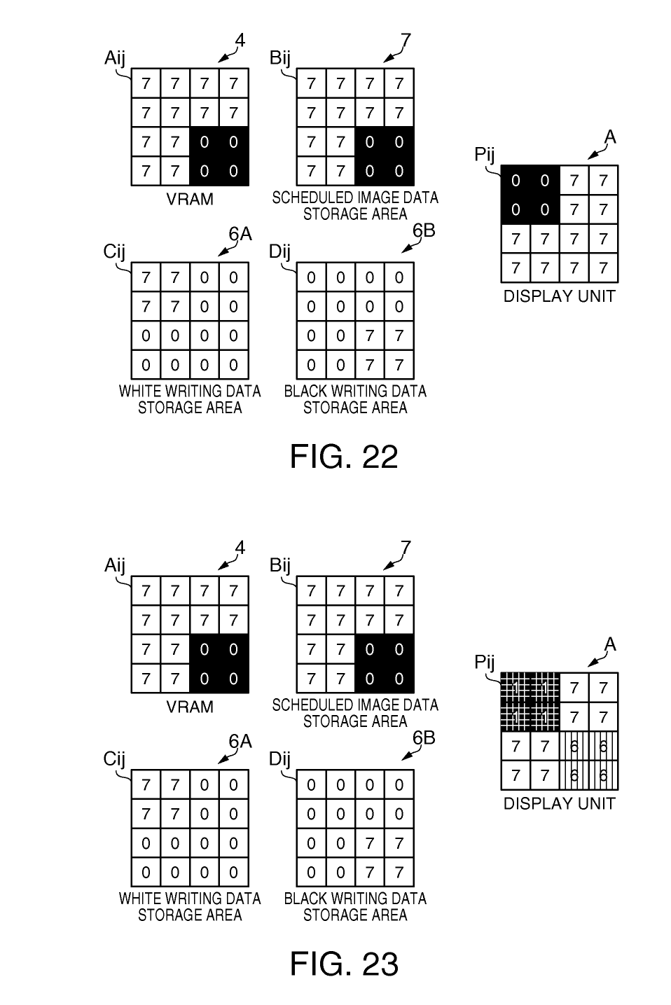

When the pixel P11 is selected in the state of FIG. 19 in step S13, a determination result of YES is obtained in step S14, and a determination result of NO is obtained in step S16. Since the content of the storage area B11 represents black and the content of the storage area All represents white, the pixel P11 is changed from black to white. Thus, “7” is written to the storage area C11 in step S17, and the content of the storage area All is written to the storage area B11 in step S18, whereby the state shown in FIG. 20 is created. Subsequently, when the pixel P12 is selected, a determination result of YES is obtained in step S14, and a determination result of NO is obtained in step S16. As a result, “7” is written to the storage area C12 in step S17, and the content of the storage area Al2 is written to the storage area B12 in step S18, whereby the state shown in FIG. 21 is created. Moreover, when the pixel P33 is selected, a determination result of YES is obtained in step S14, and a determination result of NO is obtained in step S16. Since the content of the storage area B33 represents white and the content of the storage area A33 represents black, the pixel P33 is changed from white to black. Thus, “7” is written to the storage area D33 in step S17, and the content of the storage area All is written to the storage area B11 in step S18. After that, when the pixel P44 is selected, the content of the scheduled image data storage area 7 becomes the same as the content of the VRAM 4 as shown in FIG. 22. Moreover, in the white writing data storage area 6A, “7” is written to the storage areas C11, C12, C21, and C22. In the black writing data storage area 6B, “7” is written to the storage areas D33, D34, D43, and D44.

After that, when the process of step S23 is performed, since the content of the storage area C11 in a pixel driving circuit (a pixel driving circuit corresponding to the intersection between the first scanning line 64 and the first data line 65) corresponding to the pixel P11 is not “0,” a voltage is applied to the data line 65 such that when the scanning line 64 is selected, the potential of the pixel electrode 13a is −15 V in relation to the potential Vcom of the transparent electrode layer 32. Moreover, the contents of the storage areas C12, C21, and C22 in the pixel driving circuits corresponding to the pixels P12, P21, and P22 are not “0,” a voltage is applied to the data line 65 such that when the scanning line 64 is selected, the potential of the pixel electrode 13a is −15 V in relation to the potential Vcom of the transparent electrode layer 32.

Moreover, since the content of the storage area D33 in a pixel driving circuit (a pixel driving circuit corresponding to the intersection between the third scanning line 64 and the third data line 65) corresponding to the pixel P33 is not “0,” a voltage is applied to the data line 65 such that when the scanning line 64 is selected, the potential of the pixel electrode 13a is +15 V in relation to the potential Vcom of the transparent electrode layer 32. Moreover, the contents of the storage areas D34, D43, and D44 in the pixel driving circuits corresponding to the pixels P34, P43, and P44 are not “0,” a voltage is applied to the data line 65 such that when the scanning line 64 is selected, the potential of the pixel electrode 13a is +15 V in relation to the potential Vcom of the transparent electrode layer 32.

For other pixels, since the contents of the corresponding storage areas in the white writing data storage area 6A are “0” and the contents of the corresponding storage areas in the black writing data storage area 6B are “0,” a voltage is applied to the data line 65 such that when the scanning line 64 is selected, the difference between the potential of the pixel electrode 13a and the potential Vcom of the transparent electrode layer 32 is 0 V. When the voltage is applied to the data line 65 in this way, white and black particles in the pixels move whereby the state shown in FIG. 23 is created in the display of the display unit 1.

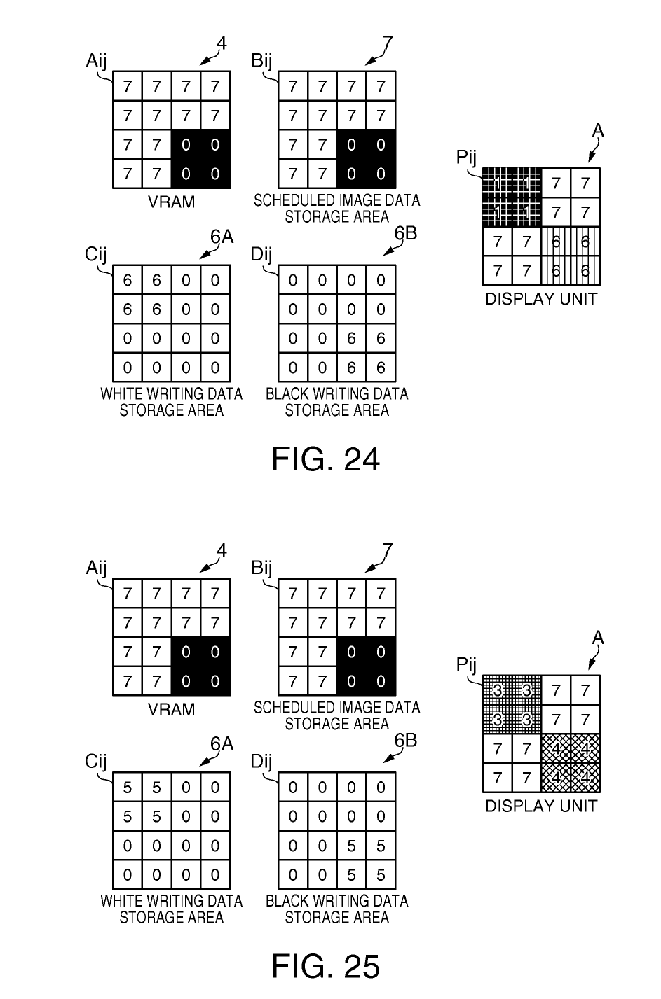

When the process of step S23 is finished, the controller 2 returns the flow of processes to step S11. When the pixel P11 is selected in the state of FIG. 23 in step S13, a determination result of NO is obtained in step S14, and “1” is subtracted from the value written in the storage area C11, so that the content of the storage area C11 is changed to “6”. Subsequently, when the pixel P12 is selected, a determination result of NO is obtained in step S14, and “1” is subtracted from the value written in the storage area C12, so that the content of the storage area C12 is changed to “6”. After that, when the pixel P44 is selected, the contents of the storage areas C11, C12, C21, and C22 are changed to “6” and the contents of the storage areas D33, D34, D43, and D44 are changed to “6” as shown in FIG. 24.

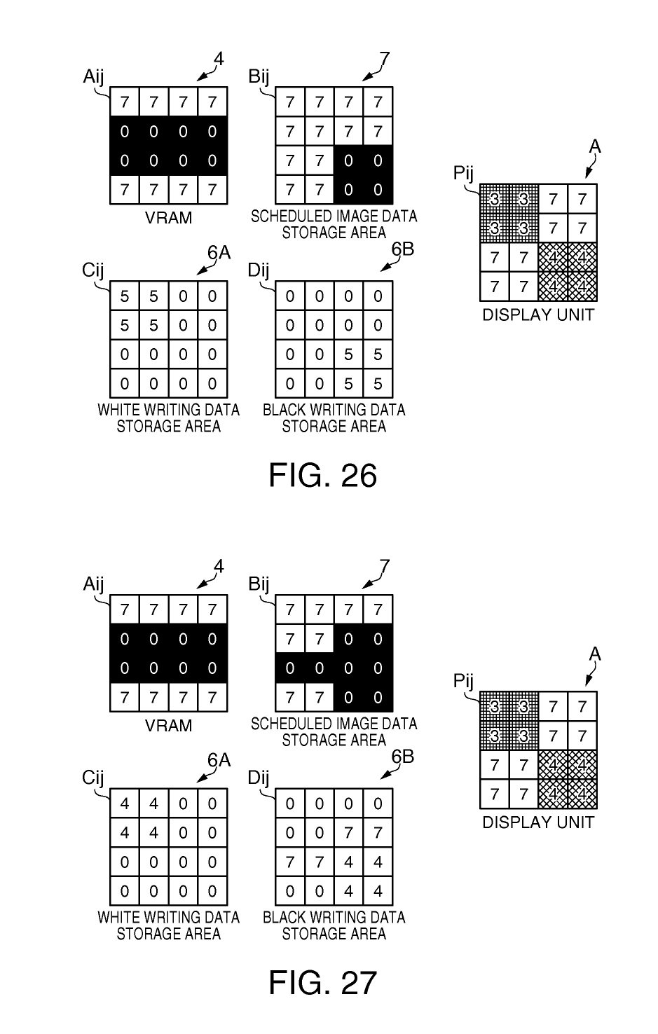

FIG. 25 is a diagram showing the state immediately after the process of step S23 is performed twice in the state shown in FIG. 24. Here, a case in which the content of the VRAM 4 is rewritten as shown in FIG. 26 will be considered. When the pixel P21 is selected in the state of FIG. 26 in step S13, a determination result of NO is obtained in step S14, and “1” is subtracted from the value written to the storage area C21 in step S15, so that the content of the storage area C21 is changed to “4”. On the other hand, when the pixel P23 is selected in step S13, a determination result of YES is obtained in step S14, and a determination result of NO is obtained in step S16. As a result, “7” is written to the storage area D23 in step S17, and the content of the storage area A23 is written to the storage area B23 in step S18. As above, even when the content of the VRAM 4 is rewritten from white to black, rewriting to white progresses in pixels in which rewriting to white is progressing, and the second writing data is stored in the black writing data storage area 6B with respect to pixels which are not rewritten. Moreover, when the pixel P43 is selected in the state of FIG. 26 in step S13, a determination result of NO is obtained in step S14, and “1” is subtracted from the value written to the storage area D43 in step S15, so that the content of the storage area D43 is changed to “4”. As above, even when the content of the VRAM 4 is rewritten from black to white, rewriting progresses in pixels in which rewriting to black is progressing.

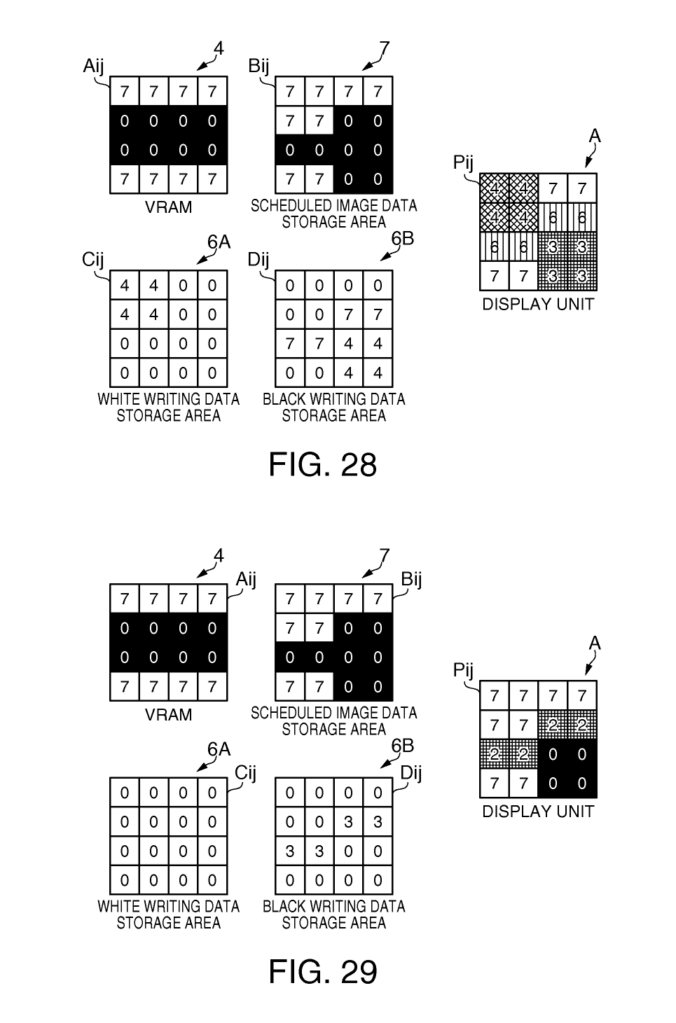

When processes are performed in the state of FIG. 26 until a determination result of YES is obtained in step S21, the state shown in FIG. 27 is created in the VRAM 4 and the respective storage areas. Moreover, when the process of step S23 is performed in the state shown in FIG. 27, the state shown in FIG. 28 is created in the display unit 1. As for pixels corresponding to portions of the VRAM 4 in which the contents are rewritten, rewriting progresses in pixels in which rewriting is progressing, and new pixel rewriting is started in pixels which are not rewritten.

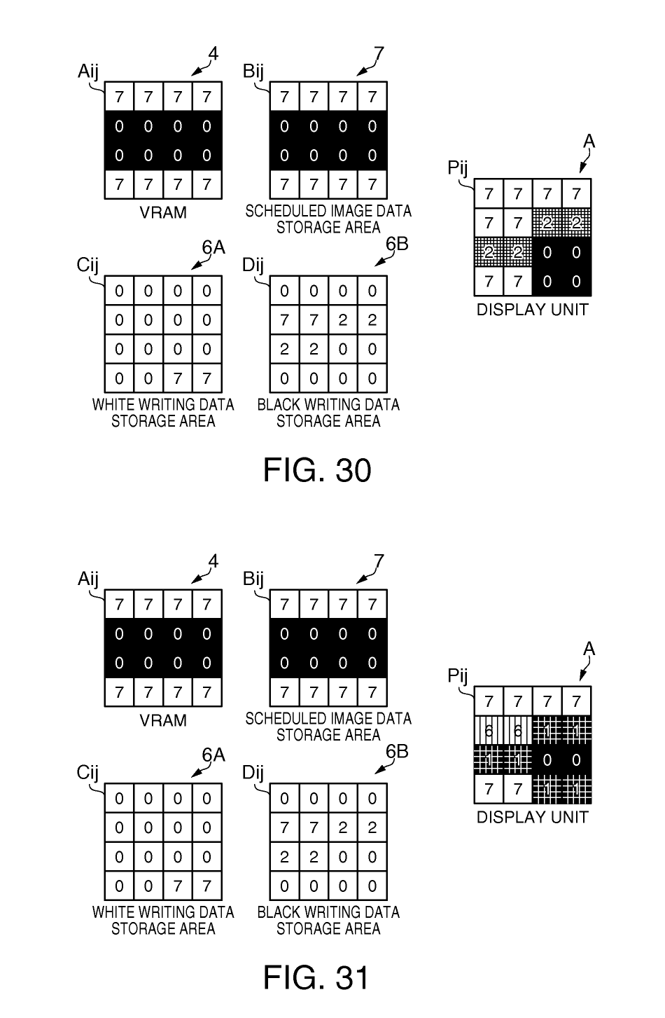

When processes progress further and the values of the first and second writing data in pixels in which rewriting has been started earlier become “0,” the state shown in FIG. 29 is created in the respective storage areas and the display unit 1. When the pixel P21 is selected in the state of FIG. 29 in step S13, a determination result of YES is obtained in step S14, and a determination result of NO is obtained in step S16. As a result, “7” is written to the storage area D21 in step S17, and the content of the storage area A21 is written to the storage area B21 in step S18. Moreover, when the pixel P41 is selected in step S13, a determination result of YES is obtained in step S14, and a determination result of NO is obtained in step S16. As a result, “7” is written to the storage area C41 in step S17, and the content of the storage area A41 is written to the storage area B41 in step S18. After that, when processes are performed until a determination result of YES is obtained in step S21, the state shown in FIG. 30 is created in the respective storage areas, and the state shown in FIG. 31 is created when the process of step S23 is performed.

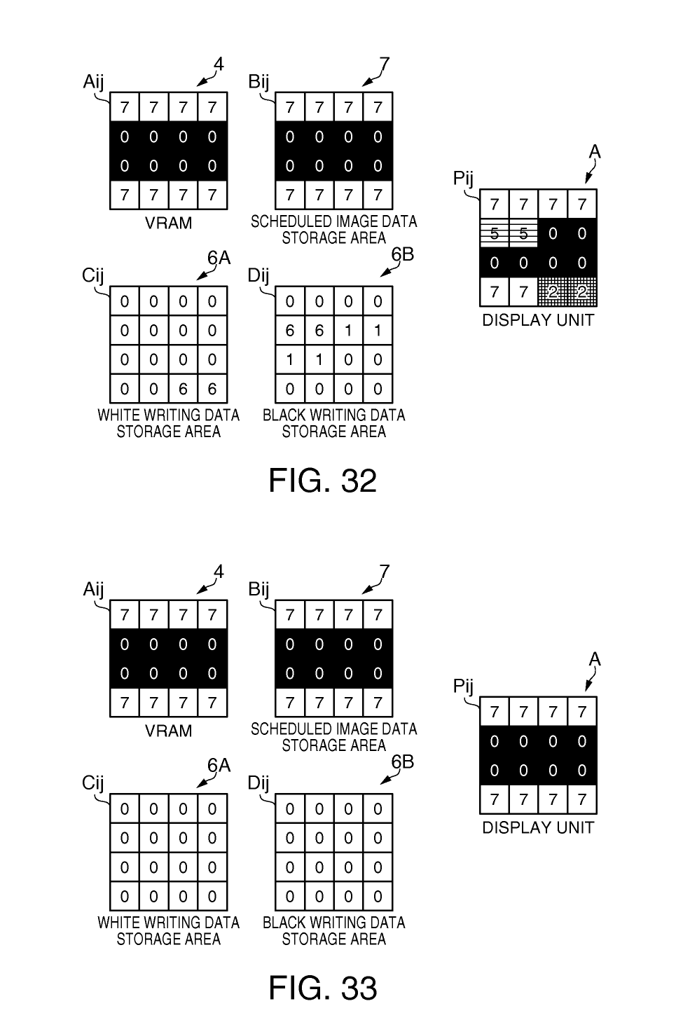

After that, when processes progress, and the process of step S23 is performed in a state where the state of FIG. 32 is created in the respective storage areas, the state shown in FIG. 32 is created in the display unit 1, and rewriting of the pixels P23, P24, P31, and P32 is finished. Moreover, when the processes progress further, the rewriting of the pixels P21, P22, P43, and P44 progresses, and finally, the state shown in FIG. 33 is created.

According to the present embodiment, even when an area in which rewriting has been started earlier overlaps with an area in which new rewriting is performed, since rewriting is started immediately in portions in which rewriting is not progressing when new rewriting is started, the user may experience a faster display speed.

Moreover, in the present embodiment, the pixel electrodes 13a of pixels within one frame can be used as a positive polarity such that they have higher potentials than the transparent electrode layer 32, and the pixel electrodes 13a of the other pixels within the same frame can be used as a negative polarity such that they have lower potentials than the transparent electrode layer 32. That is, pixel electrodes can be driven so as to be selectively used as the positive and negative polarities in relation to the transparent electrode layer 32 within one frame (hereinafter, this driving method will be referred to as dual polarity driving). More specifically, within one frame, the pixel electrodes 13a of pixels of which the gradations are changed toward the high density side are used as a positive polarity, and the pixel electrodes 13a of pixels of which the gradations are changed toward the low density side are used as a negative polarity. When the black electrophoretic particles are negatively charged, and the white electrophoretic particles are positively charged, the pixel electrodes 13a of pixels of which the gradations are changed toward the high density side may be used as a negative polarity, and the pixel electrodes 13a of pixels of which the gradations are changed toward the low density side may be used as a positive polarity. Although the dual polarity driving method is used in the present embodiment, a single polarity driving method may also be used in which a voltage for causing pixels to appear white is applied to the pixels within one frame period, and a voltage for causing pixels to appear black is applied to the pixels within another one frame period.

### Modified Example

Although the embodiment of the invention has been described hereinabove, the invention is not limited to the above-described embodiment, but may be embodied in various other forms. For example, the invention may be embodied by modifying the above-described embodiment in the following manner. Moreover, the above-described embodiment and each of the following modified examples may be combined with each other.

In the present embodiment, the electronic apparatus 1000 is not limited to an ebook reader but may be a personal computer, a PDA (Personal Digital Assistant), a smartphone, or the like.

In the personal computer, the PDA, or the smartphone, when displaying the image of the first selected page of an ebook and the thumbnail images, a program realizing the display control unit 1101, the thumbnail generation unit 1102, the selected image generation unit 1103, and the display image generation unit 1104 shown in FIG. 6 is installed and the program is executed, whereby the image of the first selected page of the ebook and the thumbnail images are displayed.

The program may be provided in a state of being stored in a computer-readable recording medium such as a magnetic recording medium (magnetic tape, magnetic disk (HDD (Hard Disk Drive), FD (Flexible Disk)), and the like), an optical recording medium (optical disc (CD (Compact Disc)), DVD (Digital Versatile Disk)), and the like), an opto-magnetic recording medium, or a semiconductor memory and may be installed in the electronic apparatus 1000. Moreover, the program may be downloaded through a communication line and installed in the electronic apparatus 1000.

Moreover, the display unit 1 included in the electronic apparatus 1000 is not limited to the electrophoretic display device using microcapsules, but other display devices such as a liquid crystal display or an organic EL (ElectroLuminescence) display may be used.

Furthermore, in the invention, the image displayed on the display unit 1 is not limited to the image of an ebook but may be the image of a document of a thesis, a report, or a material.

Moreover, in the invention, thumbnail images being displayed may be removed when the button 9B is pressed, and thumbnail images may be displayed when the button 9A is pressed in a state where the thumbnail images are not displayed. Moreover, when removing thumbnail images, the thumbnail images may be removed by scrolling downward. Furthermore, when displaying thumbnail images, the thumbnail images may be displayed by scrolling the thumbnail images upward from the lower end of the display region. In the above-described embodiment, when document data is selected by the user, the image of the selected page and thumbnail images P11 are displayed first. However, in the invention, when document data is selected by the user and the image of the page is displayed first, only the selected image P may be displayed, and the thumbnail images P11 may not be displayed.

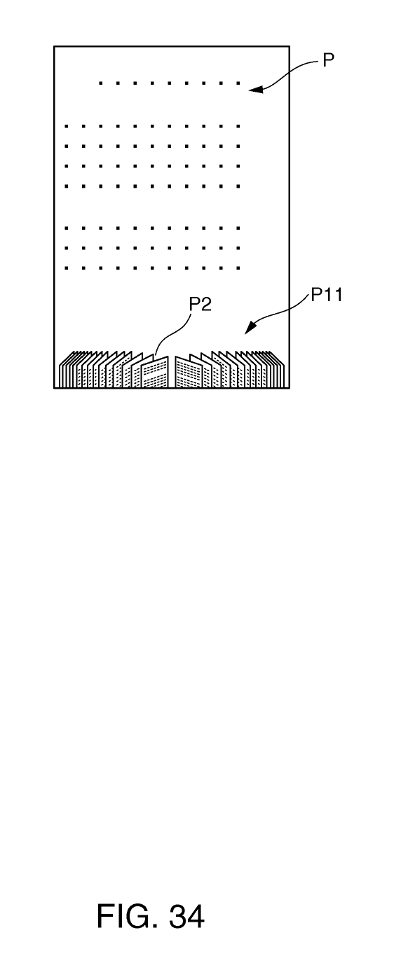

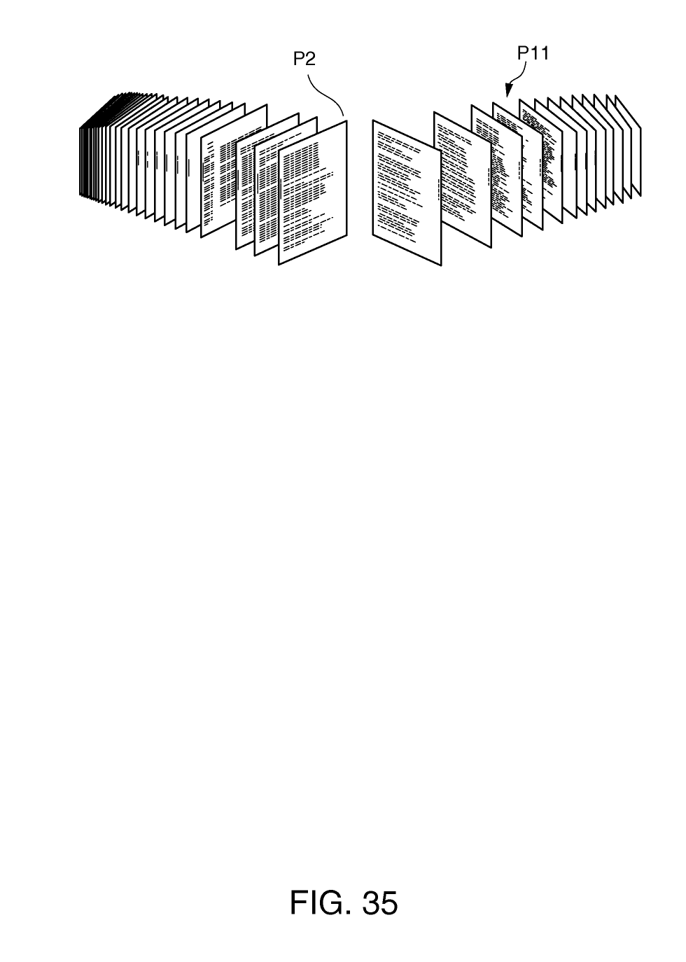

Furthermore, in the invention, an upper part of the thumbnail images, which is a predetermined range from the upper end of each page, may be displayed as shown in FIG. 34, and the lower part lower than the upper part may not be displayed. Furthermore, in the invention, when increasing the gap between thumbnail images, if the second selected page is after the first selected page, the gap between thumbnail images of pages before the second selected page may be increased whereas the gap between thumbnail images of pages after the second selected page may not be increased. If the second selected page is before the first selected page, the gap between thumbnail images of pages after the second selected page may be increased whereas the gap between thumbnail images of pages before the second selected page may not be increased. Furthermore, in the invention, the thumbnail images may be displayed so that the gap between thumbnail images of pages decreases as the distance from the thumbnail image P2 of the first selected page increases. Furthermore, in the above-described embodiment, although the thumbnail images are displayed so as to overlap with the adjacent thumbnail images, the thumbnail images of pages in a predetermined range from the first selected page may be displayed so as not to overlap with each other.

In the invention, the thumbnail image size may be determined in advance, and the thumbnail image size may be changed in accordance with the operation of the user. Moreover, when the electronic apparatus 1000 is a personal computer, the personal computer may acquire the resolution of a display device displaying images and change the thumbnail image size in accordance with the acquired resolution. Furthermore, in the invention, the thumbnail image of the first selected page may have a larger size than the thumbnail images of pages other than the first selected page. Furthermore, in the invention, the thumbnail image of the second selected page may also have a larger size than the thumbnail images of pages which are before and after the second selected page. Furthermore, in the invention, the thumbnail image of the first selected page may have the largest size, and the thumbnail image size may decrease as the distance from the first selected page increases. Furthermore, in the invention, thumbnail images of pages within a predetermined range from the first selected page may have the same size as the first selected page, and thumbnail images of pages outside the range may have a smaller size than the thumbnail image of the first selected page.

In the above-described embodiment, the thumbnail images have been arranged in ascending order of page numbers from the right to the left of the display region. However, in the invention, the thumbnail images may be arranged in descending order of page numbers from the right to the left of the display region. Moreover, in the invention, as shown in FIG. 35, thumbnail images displayed on the left side of the thumbnail image of the first selected page may be displayed so as to be inclined upward as the distance from the first selected page increases. Moreover, thumbnail images displayed on the right side of the thumbnail image of a page which is one page before the first selected page may be displayed so as to be inclined upward as the distance from the thumbnail image of the page which is one page before the first selected page increases.

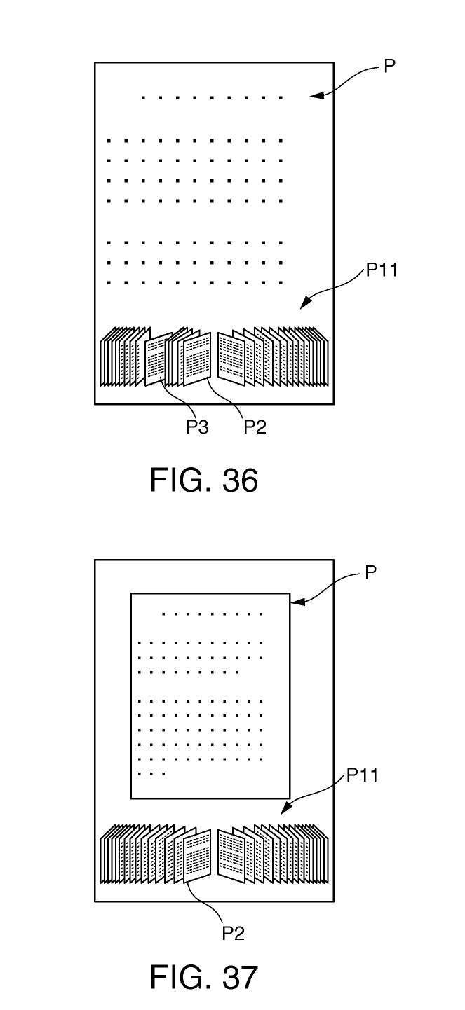

In the invention, the thumbnail image of the second selected page may have a smaller rotation angle than the thumbnail images of pages which are before and after the second selected page as shown in FIG. 36. Moreover, in the above-described embodiment, the thumbnail images of pages before the first selected page have been rotated about the rotation axis M in a direction opposite to the rotation direction of the thumbnail image of the first selected page. However, in the invention, the thumbnail images of pages before the first selected page may be rotated in the same rotation direction as the thumbnail image of the first selected page. Moreover, in the invention, the rotation angle θ1 of the first selected page may be 0°. Furthermore, in the invention, the rotation angles of the respective thumbnail images may be the same. Furthermore, in the invention, the thumbnail images of pages within a predetermined range from the first selected page may have the same rotation angle as the thumbnail image of the first selected page. Furthermore, in the invention, the thumbnail images of pages outside the predetermined range from the first selected page may have a larger rotation angle than the thumbnail image of the first selected page.

In the invention, as shown in FIG. 37, the image of the first selected page and the thumbnail images may be arranged and displayed so that the image of the first selected page does not overlap with the thumbnail images.

Moreover, in the above-described embodiment, both the first selected image P and the thumbnail images P11 have been displayed at the same time. However, in the present embodiment, only the thumbnail images P11 may be displayed without displaying the first selected image P. When displaying only the thumbnail images P11, the thumbnail images may have a larger size than that when they are displayed together with the first selected image P.

In the invention, a position input device that acquires information of a position of the display unit 1 which is touched by a stylus pen may be provided to the electronic apparatus 1000. The position or the moving trajectory of the stylus pen may be acquired based on the position information obtained by the position input device, and the respective units of the electronic apparatus 1000 may be controlled in accordance with the acquired position or moving trajectory. Moreover, a function of inputting a search keyword may be provided so as to search for a page including a keyword input by the stylus pen. Moreover, the page found through searching may be used as the second selected page, and the second selected page found through searching may be displayed with a gap between the second selected page and pages which are before and after the selected page similarly to the above-described embodiment. A number of second selected pages may be found through searching.

The entire disclosure of Japanese Patent Application No. 2011-026365, filed Feb. 9, 2011 is expressly incorporated by reference herein.

What is claimed is:

1. A display control method for displaying thumbnail images of respective pages of one document having a plurality of pages on a display unit, comprising:
generating an image in which respective thumbnail images of the plurality of pages are arranged in a predetermined direction based on the sequence of pages so as to partially overlap with adjacent thumbnail images, at least a thumbnail image of a first selected page selected from the plurality of pages is disposed on the frontmost surface, and the gap between a thumbnail image of a second selected page other than the first selected page and a thumbnail image of a page which is before or after the second selected page is larger than before the second selected page is selected; and
displaying the image generated in the generating on the display unit.

2. The display control method according to claim 1,
wherein the respective thumbnail images of the plurality of pages are images in which the corresponding page is erected on a horizontal plane provided within an imaginary space and rotated from a predetermined reference position within the imaginary space about an imaginary rotation axis crossing the horizontal sides of the page, and the page is viewed overhead within the imaginary space.

3. The display control method according to claim 1,
wherein a rotation angle of the thumbnail image of the second selected page is smaller than the rotation angle of each of the thumbnail images of pages which are before and after the second selected page.

4. The display control method according to claim 1,
wherein a plan-view image of the first selected page having a larger size than the thumbnail image is displayed together with the respective thumbnail images of the plurality of pages.

5. The display control method according to claim 1,
wherein the display unit includes a plurality of scanning lines, a plurality of data lines, and a plurality of pixels formed corresponding to the intersections between the plurality of scanning lines and the plurality of data lines and changes the gradation of the pixels by a writing operation of applying a voltage to the pixels several times, and
wherein the method further includes
determining pixels of which the gradation is to be changed among the plurality of pixels by comparing image data representing an image to be newly displayed on the display unit and scheduled image data representing an image scheduled to be displayed on the display unit by the writing operation in progress, and
starting the writing operation with respect to pixels which are determined to be the pixels of which the gradation is to be changed and in which the writing operation is not being performed so that the pixels have a gradation set by the image data, and starting the writing operation with respect to pixels which are determined to be the pixels of which the gradation is to be changed and in which the writing operation is being performed so that the pixels have a gradation set by the image data after the writing operation being performed is finished.

6. A display apparatus comprising:
a display unit that displays thumbnail images of respective pages of one document having a plurality of pages;
a display image generation unit that generates an image in which respective thumbnail images of the plurality of pages are arranged in a predetermined direction based on the sequence of pages so as to partially overlap with adjacent thumbnail images, at least a thumbnail image of a first selected page selected from the plurality of pages is disposed on the frontmost surface, and the gap between a thumbnail image of a second selected page other than the first selected page and a thumbnail image of a page which is before or after the second selected page is larger than before the second selected page is selected; and
a controller that causes the image generated by the display image generation unit to be displayed on the display unit.

7. An electronic apparatus comprising the display apparatus according to claim 6.
